(19) United States
(12) Patent Application Publication
(10) Pub. No.: US 2011/0289020 A1
(43) Pub. Date: Nov. 24, 2011

(54) Using a selected media for soliciting donation

(76) Inventor: Maria Erlinda Co Sarno, Cerritos, CA (US)

(21) Appl. No.: 12/800,748

(22) Filed: May 21, 2010

(51) Int. Cl. G06Q 90/00

(52) U.S. Cl. 705/500

(57) ABSTRACT

A method for enhancing solicitation of donation through the use of a selected media having a combined property of a personal relationship to a donor or honoree, informational, and accommodating a number of donors or honoree. The media can be placed on a template having a drawing or replica of the media divided into multiple sections, with each section having an independent information available for sponsorship.

### BACKGROUND

Charitable donations are harder and harder to get especially in times when the need for these funds are more pronounced such as during poor economic conditions where even charitably inclined donors are less likely to give because their own financial stability is not assured. Causes alone are no longer as effective as before in convincing the donors. Further, the number of charities soliciting donations for the same cause have increased in number with the number of donors not necessarily increasing proportionately.

The method presented here is different from the conventional method. The method attracts a donor beyond touching on one's desire to leave a lasting momento and the desire to help the needy. This method employs a medium that has a relationship or significance on the life of the donor or honoree or closely associated with the accomplishment or career of the donor/s or honoree. The media also provide information usually educational as well as open to a number of donor participation. Although ‘medium’ is the correct term to use for a singular item and ‘media’ for more than one item, ‘media’ hereinafter will be the term used collectively as well as refer to singular or more than one medium. Honoree here means the person to whom a donor donates in memory or in honor of. Most known methods of soliciting donation in combination with the posting/inscribing of the name of the donors or honoree include but is not limited to using media such a board on a wall, replica of leaves on a tree or blocks making up a walkway or a wall where the donors/honorees' names are inscribed. All these media by itself provide no close personal relationship or significance to the donor, that is, it does not trigger a personal feeling or memory except that the media is usually located in a place most frequented, cherished, favored or stayed at by the donor such as at a hospital for donors that are in the medical field or have been a patient. These media also provide no additional information to the reader. Placing the name of the donor or honoree on a media such as an equipment, apparatus or room in a facility once used by a donor or honoree, although the media also trigger a personal affinity, do not meet the guidelines or requirements because these media are usually open only to individual donors or to one class of donors and not open for a number of donor participation on a single item or room. Some of these are also not informational.

As stated, a proposed media must have all the following properties, most importantly, having a close relationships with the donor, accommodating participation from a number of donors on the same media as well as provide information, preferably educational, to the reader or observer. Examples include but is not limited to media closely associated with the donor/honoree such as his/her profession, birthplace, accomplishments, discoveries, hobbies which are at the same time informational to the readers. These media may be preexisting and they have their own usage or application. This method provides a new use for these media. To enhance a successful outcome, the organization conducting the solicitation should also have some relationship with target donors and as in the conventional methods, the media is recommended to be located at a place most frequented, cherished, favored or stayed at by the donor. For example, if the target donors/honorees are scientists, it would be best for a science institution to conduct the donor solicitation and display the media on one of the walls in the hallway.

It is an object of the invention to provide a method for enhancing donations using a media with a close personal relationship to the donor or honoree.

It is also an object of this invention to use a media where a number of donors can be solicited and their personal information is inscribed at the same media without easily exhausting the number of available spaces on the media.

It is a further object of the invention to use a media that is not only personal to the donor/honoree but is also informational or educational to the reader or place where the media is displayed.

### BRIEF DESCRIPTION OF THE DRAWING

Aspects of the present invention are illustrated by way of example, and not by way of limitation, in the accompanying drawings, wherein:

FIG. 1 is a plan view of the Periodic Table template divided into multiple sections with each section containing an element.

FIG. 1A is the key on what is inside each section of the periodic table.

FIG. 1B is an isolated plate or section matching a section of an element inscribed or printed on the Periodic Table template of FIG. 1

### SUMMARY OF THE INVENTION

This invention relates to a method for enhancing solicitation of donation through the use of a selected media comprising the steps of providing a media having a combined property of a personal relationship to a donor or honoree, informational, and accommodating a number of donors or honoree; providing a template having a drawing or replica of the media divided into multiple sections, each section having an independent information; hanging or displaying the template or replica in a conspicuous place frequented or cherished by targeted donors and honoree; preparing a matching plate for each section of the media; soliciting donors for a cause; announcing the media where a donor or honoree's name will be inscribed; inscribing the name of the donor or honoree on the matching plate chosen by the donor; attaching the matching plate having the donor or honoree's personal information to the matching section of the media on the template; and, continue soliciting until all sections of the media are covered. Template refers to a flat or planar surface such as a board having the media drawn or printed or to a three dimensional structure serving as or showing the backbone of the media. A matching plate is one that attaches to the section of the template on the template bearing the same information but having in it, the name of the donor. The personal information about the donor or honoree usually will contain at least the donor or honoree's name. It may contain other personal information aside from just the name. Instead of preparing matching plates, one can simply color each section of the media on the template as they are taken or color the inscription or the selected section with a different color than the one used for inscribing the information on the template. Because the matching plates will protrude more or parts of the template will be colored as these are sponsored, it is easy to tell which sections are still available.

Adopting this method to the us of the Periodic Table as the media, a board that can hang on a wall is best suited as the template to use. The Periodic Table can be conveniently divided into multiple section because in its conventional representation, the elements are already separated from each other by a grid. The Periodic Table template is recommended to be hanged where the targeted donors can see it or for example, at the hosting organization or educational institution soliciting the donation from its students, faculty members or alumni. Each element of the Periodic Table can have a matching plate where the personal information of the donor or honoree will be inscribed before it is attached to the section on the Periodic Table template showing the same element as this element is sponsored. Instead of preparing matching plates, one could simply just paint the elements and symbols or the entire section with another color as they are taken.

### DETAILED DESCRIPTION OF THE INVENTION

The detailed description represented herein is not intended to represent the only way or the only embodiment in which the claimed invention may be practiced. The description herein is provided merely as an example or examples or illustrations of the claimed invention and should not be construed as the only way or as preferred or advantageous over other embodiments or means of practicing the invention. Any use of a media fitting the description of the type of media used here for soliciting donations is within the scope of this invention. The detailed description includes specific details to provide a thorough understanding of the claimed invention and it is apparent to those skilled in the art that the claimed invention may be practiced without these specific details.

Media that can be used in this method of solicitation are numerous as long as they fit the description and properties of the media, that of having a personal relationship to the donor/honoree, informational, and capable of accepting a number of donor participation. Examples shown here are not exhaustive but is meant only to provide a thorough understanding of the claimed invention. An example of a media is a map that can be used to solicit donor/honoree by a locality, agency or an organization especially those having a diverse community/membership where the donor/honoree would choose to sponsor their birthplace or a memorable place they have association with in their life. The map can be a street within a city map, a city map, a state map, a country map or a global map depending upon who the target donors are. Any map of course is informational. Every block; street, city, state, country on the map can be sponsored. The donor maps can be displayed inside an agency, school, park, office, etc.

A Botany Department may use a display of several plants or flowers that have been cultured, studied or cross bred by the department through the years that the department takes pride of. Here the botanists, students or technicians involved with their families and friends would be the likely donors or honorees. The latter can be expanded as more plants and flowers are discovered or researched on by the department. Also, in these, donors with the same name as the plant or flower will be more likely to sponsor that particular plant or flower.

This method of solicitation as shown spans across many classes or fields of application and discipline. Each class of targeted donors usually have a common cherished item or symbol that they can use as media so long as this have the properties of the media as described. The media need not be one that can be hanged or displayed in a wall. It may be three dimensional such as a three dimensional helical structure of a gene or a three dimensional protein with the amino acid making up the protein. In the field of music, each note in a song or a replica of a piano can be used with each key available for sponsorship or donation. The song can be the alma mater song and each note can have a photo of the donor.

The method described in detail here, as example, presents a new use of the Periodic Table which is currently used in the classroom setting as well as in research to provide resource information on the properties or a property of the elements identified in the Periodic Table. Here it is used as the media for solicitation. The Periodic Table is a good example of a media because it is not only personal to every scientists that have worked closely with the Periodic Table either during their school days or in their career but it is also still educational to the reader or observer, albeit having the personal information of the donor/honoree inscribed somewhere near the symbol of the element. The media in itself will draw the attention of a passerby to stop and look at the media which consequently will also draw him or her to read the donor or honoree's name. Further, every element in the Periodic Table is available to a donor for sponsorship.

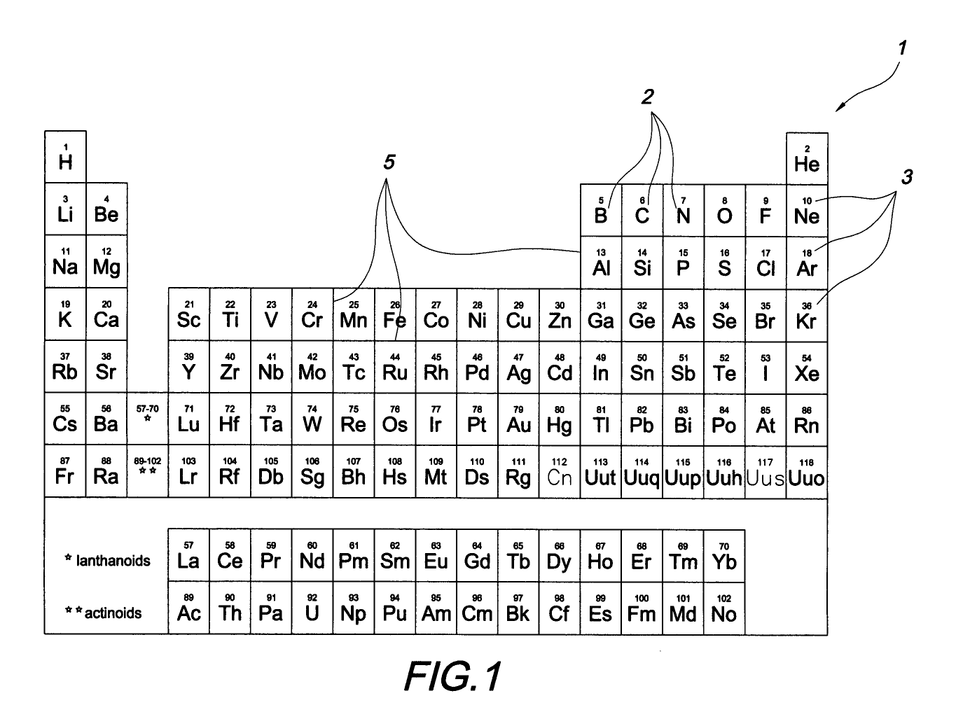

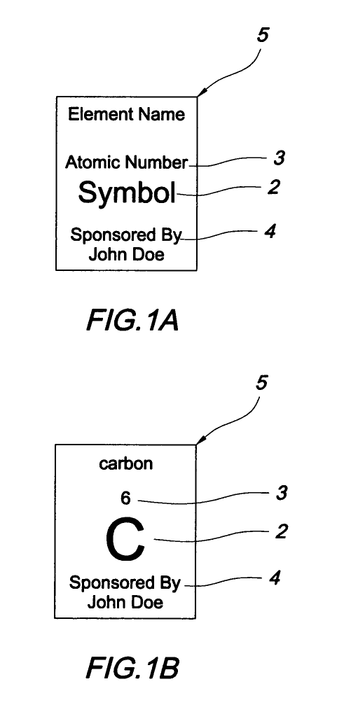

FIG. 1 is a plan view of a Periodic Table 1 of elements. Being used for solicitation and not as a teaching device, it need not have all the contents or complete information for each element. The shape of the usual representation of the Periodic Table or any media used can be modified for artistic purpose so long as it does not take away the educational or informational property of the media. A Periodic Table media will trigger a feeling of belonging to scientists especially chemists so as to persuade them to contribute or sponsor element/s in the Periodic Table. Personal relationship reasons could be, for example, choosing P or S by those who have worked with the elements Phosphorus and Sulfur. Californium will be attractive to one residing or born in California. A Periodic Table 1 also provides an additional unique property aside from its relationship with a profession or a class of donors stated above. Similar to the flowers and plants above, here, the symbol 2 of the elements will be unusually more attractive to donors whose name or last name starts or is the same as the symbol. For example, Co for Cobalt will be very attractive to a Chinese donor having a full last name of Co. Chinese usually have short last names and may be fully spelled by the symbol of the element. Persons having the same initials as the elements would also be attracted to donate and sponsor that element matching their initials. The Periodic Table also as a media touches on the ego of a donor. The atomic number 3 instead of the symbol will be attractive for example, to a batch of students graduating or graduated at the year represented by the atomic number, that is, graduates of 1978 will likely sponsor Pt, the element with the atomic number 78. The number 3 can also be chosen by those who were born in the same year. Each donor will have their own personal reason or a want that will be fulfilled or satisfied aside from the desire to give for a cause. The donor or honoree information 4 will usually be inscribed below the symbol of the element. However, any space inside each element is available for notation. This media also allows participation from a number of donors because each element, usually separated from each other by a grid 5, is available for sponsorship by a donor. While it is used as a media to be more attractive to donors, the Periodic Table as displayed is still informational.

The method for enhancing solicitation of donation generally includes the step of providing a media having a combined property of a personal relationship to a donor or honoree, informational, and accommodating a number of donors or honoree; providing a template having a drawing or replica of the media divided into multiple sections, each section having an independent information; hanging or displaying the template or replica in a conspicuous place frequented or cherished by targeted donors and honoree; preparing a matching plate for each section of the media; soliciting donors for a cause; announcing the media where a donor or honoree's personal information will be inscribed; inscribing the personal information of the donor or honoree on the matching plate chosen by the donor; attaching the matching plate having the donor or honoree's personal information to the matching section of the media on the template; continue soliciting until all sections of the media are covered. Template here refers to a flat or planar surface such as a board having the media drawn or printed or to a three dimensional structure serving as or showing the backbone of the media. A matching plate is the one attached to the section of the template bearing the same information but having in it, the personal information of the donor. Depending upon the size of each section, the information 4 about the donor or honoree may contain other personal information aside from just the name. Instead of preparing matching plates, one can simply color each section or the inscription on the section of the media as they are taken. Because the matching plates will protrude more or parts of the template will be colored as these are sponsored, it is easy to tell which sections are still available for donation.

Adopting this method to the Periodic Table, a board that can hang on a wall is best suited as the template to use. There are many ways one can decide on how to fill in the Periodic Table and display the elements that have been sponsored from the elements that are still available for sponsorship. One way is to print or inscribed the entire Periodic Table on the template board as shown in FIG. 1. The Periodic Table can be conveniently divided into multiple section because each element is already separated from each other by a grid 5. Each element inside a rectangle as shown is a section and this has its own independent information. The template is recommended to be hanged where the targeted donors can see it or for example, at the hosting organization or educational institution soliciting the donation from its students, faculty members or alumni along with their families and friends. Each element will have a matching plate where the personal information of the donor will be inscribed before it is attached to the section on the template showing the same element. As an element is sponsored, that particular plate will be attached to the template. Consequently, the sponsored element will protrude more than those that are still available. Another method, instead of preparing matching plates, one could simply just paint the elements and symbols or the section with another color different from that used to print or inscribe the template as they are taken. Having a view of what has been taken and what are still available also inspire the solicitors to intensify their marketing effort especially when only a few elements are left available.

While the embodiments of the present invention have been described, it should be understood that various changes, adaptations, and modifications may be made therein without departing from the spirit of the invention and the scope of the claims.

I claim:

1. A method for enhancing solicitation of donation, comprising:
a) providing a media having a combined property of a personal relationship to a donor or honoree, informational, and accommodating a number of donors or honoree;
b) providing a template having a drawing or replica of the media divided into multiple sections, each section having an independent information;
c) hanging or displaying the template or replica in a conspicuous place;
d) preparing a matching plate for each section of the media;
e) soliciting donors for a cause including announcing the media where a donor or honoree's personal information will be inscribed;
f) inscribing the personal information of the donor or honoree on the matching plate chosen by the donor; and,
g) attaching the matching plate having the donor or honoree's personal information to the matching section of the media on the template.

2. The method of claim 1 wherein the template is displayed at a place frequented or cherished by targeted donors and honoree;

3. The method of claim 1 wherein the template is flat, planar or three dimensional.

4. The method of claim 1 wherein the shape or usual representation of the media is modified for artistic purpose.

5. The method of claim 1 wherein the media touches on the ego of a donor.

6. A method for enhancing solicitation of donation, comprising:
a) providing a media having a combined property of a personal relationship to a donor or honoree, informational, and accommodating a number of donors or honoree;
b) providing a template having a drawing or replica of the media divided into multiple sections, each section having an independent information;
c) hanging or displaying the template or replica in a conspicuous place;
d) soliciting donors for a cause including announcing the media where a donor or honoree's personal information will be inscribed; and,
e) inscribing the personal information of the donor or honoree at the section on the template chosen by a donor or honoree.

7. The method of claim 6 wherein the template is displayed at a place frequented or cherished by targeted donors and honoree;

8. The method of claim 6 wherein the template is flat, planar or three dimensional.

9. The method of claim 6 wherein the shape or usual representation of the media is modified for artistic purpose.

10. The method of claim 6 wherein the media touches on the ego of a donor.

11. A method of using a Periodic Table as a media for soliciting donors, comprising:
a) providing a surface having the Periodic Table inscribed on its outside surface;
b) dividing the Periodic Table into multiple sections, each section representing an element having an independent information;
c) hanging or displaying the template or replica in a conspicuous place;
d) soliciting donors for a cause including announcing the Periodic Table as the media where a donor or honoree's personal information will be inscribed; and,
f) inscribing the personal information of the donor or honoree at the section of the Periodic Table representing the element chosen by the donor or honoree.

12. The method of claim 11 further comprising the steps of preparing a matching plate for each element at a section of the Periodic Table after step b) and attaching the matching plate having the donor or honoree's personal information inscribed to the matching section of the Periodic Table.

13. The method of claim 12 wherein the shape or usual representation of the Periodic Table is modified for artistic purpose.

14. The method of claim 11 wherein the template is displayed at a place frequented or cherished by targeted donors and honoree;

15. The method of claim 11 wherein the template is flat, planar or three dimensional.

16. The method of claim 11 wherein the media touches on the ego of a donor.
